(19) United States
(12) Patent Application Publication
(10) Pub. No.: US 2023/0271807 A1
(43) Pub. Date: Aug. 31, 2023

(54) METHOD AND AN APPARATUS FOR ELEVATOR SYSTEM

(71) Applicant: KONE Corporation, Helsinki (FI)

(72) Inventors: Mika BELOV, Helsinki (FI); Ari KATTAINEN, Helsinki (FI); Henry SILVENNOINEN, Helsinki (FI)

(73) Assignee: KONE Corporation, Helsinki (FI)

(21) Appl. No.: 18/142,893

(22) Filed: May 3, 2023

Related U.S. Application Data
(63) Continuation of application No. PCT/FI2020/050881, filed on Dec. 31, 2020.

(51) Int. Cl. B66B 3/00; B66B 1/46

(52) U.S. Cl. CPC B66B 3/006; B66B 1/468; B66B 2201/103; B66B 2201/223; B66B 2201/232

(57) ABSTRACT

According to an aspect, there is provided a method and an apparatus. In the solution, an elevator call indication associated with a user is obtained. First guidance information is caused to be provided for the user to proceed to a waiting area. Location data associated with the user is obtained, the location data providing information about the location of the user. An elevator car is allocated in response to the elevator call indication, wherein the allocation takes into account the location of the user.

### BACKGROUND

An elevator call is usually made when a passenger arrives at an elevator lobby and presses a landing call button or makes a destination call. Depending on the size of the building in question, it may take some time while the elevator is able to serve the passenger’s elevator call. It may also be possible to make an elevator call, for example, a destination call, beforehand if the passenger is able to use a mobile device application that enables the passenger to make the elevator call remotely.

However, when making an elevator call in a building comprising several elevators, this may lead to a situation in which users who all have placed their elevator calls and are waiting for their elevators to arrive, end up waiting in a small area close to the elevators. This may cause difficulties, for example, when the users try to enter their elevators when the elevators arrive.

### SUMMARY

According to a first aspect, there is provided a method comprising obtaining an elevator call indication associated with a user; causing provision of first guidance information for the user to proceed to a waiting area; obtaining location data associated with the user, the location data providing information about the location of the user; and allocating an elevator car in response to the elevator call indication, wherein the allocation takes into account the location of the user.

In an implementation form of the first aspect, causing provision of first guidance information to the user comprises causing provision of the first guidance information with at least one of a display associated with the location of the user, a voice announcement and with a mobile application used by the user.

In an implementation form of the first aspect, the method further comprises causing provision of second guidance information associated with the allocated elevator car for the user.

In an implementation form of the first aspect, causing provision of second guidance information associated with the allocated elevator car for the user comprises causing provision of the second guidance information with at least one of a display associated with the location of the user, a voice announcement and with a mobile application used by the user.

In an implementation form of the first aspect, the method further comprises determining for the user a specific waiting location in the waiting area.

In an implementation form of the first aspect, determining for the user a specific waiting location in the waiting area comprises determining the waiting location by distancing the user from at least one other user in the waiting area.

In an implementation form of the first aspect, the method further comprises, before determining for the user a specific waiting location in the waiting area, obtaining location tracking data associated with other users in the waiting area, and distancing the user from at least one other user based on the location data associated with the at least one other user.

In an implementation form of the first aspect, the method further comprises changing the size and/or location of the waiting area dynamically.

In an implementation form of the first aspect, the method further comprises obtaining location data associated with at least one other user, the location data providing information about the location of the at least one other user; and wherein allocating an elevator car in response to the elevator call indication comprises allocating the elevator car by taking into account the locations of the at least one other user in the waiting area.

In an implementation form of the first aspect, allocating an elevator car in response to the elevator call indication comprises allocating the elevator car by taking into account at least one of existing elevator calls and elevator call indications associated with other users.

In an implementation form of the first aspect, the location data is obtained from an external monitoring system.

According to a second aspect, there is provided an apparatus comprising means for obtaining an elevator call indication associated with a user; means for causing provision of first guidance information for the user to proceed to a waiting area; means for obtaining location data associated with user, the location data providing information about the location of the user; and means for allocating an elevator car in response to the elevator call indication, wherein the allocation takes into account the location of the user.

In an implementation form of the second aspect, the means for causing provision of first guidance information to the user are configured to cause provision of the first guidance information with at least one of a display associated with the location of the user, a voice announcement and with a mobile application used by the user.

In an implementation form of the second aspect, the apparatus further comprises means for causing provision of second guidance information of the allocated elevator car for the user.

In an implementation form of the second aspect, the means for causing provision of second guidance information of the allocated elevator car to the user are configured to cause provision of the second guidance information with at least one of a display associated with the location of the user, a voice announcement and with a mobile application used by the user.

In an implementation form of the second aspect, the apparatus further comprises means for determining for the user a specific waiting location in the waiting area.

In an implementation form of the second aspect, the means for determining for the user a specific waiting location in the waiting area are configured to determine the waiting location by distancing the user from at least one other user in the waiting area.

In an implementation form of the second aspect, the apparatus further comprises means for obtaining location data associated with at least one other user in the waiting area before determining for the user a waiting location in a waiting area, and means for distancing the user from the at least one other user based on the location data associated with the at least one other user.

In an implementation form of the second aspect, the apparatus further comprises means for changing the size and/or location of the waiting area dynamically.

In an implementation form of the second aspect, the apparatus further comprises means for obtaining location data associated with at least one other user, the location data providing information about the location of the at least one other user, and wherein the means for allocating an elevator car in response to the elevator call indication are configured to allocate the elevator car by taking into account the location of the at least one other user.

In an implementation form of the second aspect, the means for allocating an elevator car in response to the elevator call indication are configured to allocate the elevator car by taking into account at least one of existing allocated elevator calls and elevator call indications associated with other users.

In an implementation form of the second aspect, the location data is obtained from an external monitoring system.

According to a third aspect, there is provided an elevator system comprising a plurality of elevator cars and the apparatus of the second aspect.

According to a fourth aspect, there is provided a computer program comprising program code, which when executed by at least one processing unit, causes the apparatus of the second aspect to perform the method of the first aspect.

According to a fifth aspect, there is provided a computer-readable medium comprising a computer program comprising program code which when executed by at least one processing unit, causes the apparatus of the second aspect to perform the method of the first aspect.

According to a sixth aspect, there is provided an apparatus for allocating an elevator. The apparatus comprises at least one processor, and at least one memory connected to the at least one processor. The at least one memory stores program instructions that, when executed by the at least one processor, cause the apparatus to obtain an elevator call indication associated with a user; cause provision of first guidance information for the user to proceed to a waiting area; obtain location data associated with the user, the location data providing information about the location of the user; and allocate an elevator car in response to the elevator call indication, wherein the allocation takes into account the location of the user.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a flow chart of a method according to an example embodiment.

FIG. 2A illustrates elevator system elements according to an example embodiment.

FIG. 2B illustrates elevator system elements according to an example embodiment.

FIG. 3 illustrates a block diagram of an apparatus for allocating an elevator according to an example embodiment.

### DETAILED DESCRIPTION

In the following some example embodiments may illustrate that a location of a user, who has provided an elevator call indication, can be taken into account when allocating the actual elevator call for the elevator call indication.

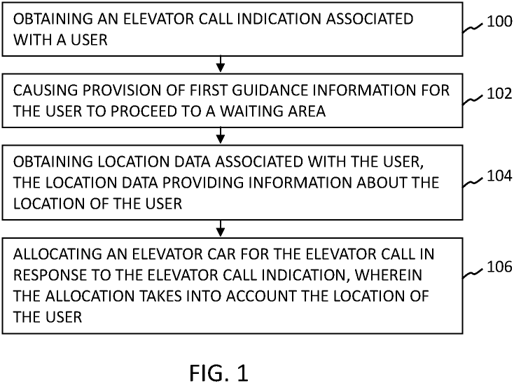

FIG. 1 illustrates a flow chart of a method according to an example embodiment.

At 100 an elevator call indication associated with a user is obtained. The elevator call indication may be obtained, for example, as a destination call from a mobile application executed by a mobile device of the user, or from a destination operating panel (DOP) that may be arranged in vicinity of elevators. The term “elevator call indication” used herein may mean, for example, that the user provides a floor call or alternatively a destination call with a destination operating panel (DOP) or an application executed on a mobile device of the user. At this point, the elevator system receives the indication but may not yet immediately allocate an elevator car in response to the indication. In another example embodiment, the elevator call indication may be provided with the application executed on the mobile device of the user automatically when the user reaches a specific location. The user’s location may be established, for example, based on satellite positioning data, indoor positioning data, user identification at a specific location in a building, short-range wireless communication etc.

At 102 provision of first guidance information is caused for the user to proceed to a waiting area. The user may be given some guidance information, for example, with the user’s mobile device. In another example embodiment, the destination operating panel may provide the guidance information, or a separate display arranged in vicinity of the destination operation panel may provide the guidance information. Yet in another example embodiment, a voice announcement may be provided to the user. In an example embodiment, guidance information may guide the user to a specific spot in the waiting area, or it may guide the user to a more general direction in the waiting area. The waiting area may refer to an elevator lobby area in vicinity of the elevators. In another example embodiment, the waiting area may be arranged further away from the elevators or the waiting area may be formed by smaller separate waiting areas.

In an example embodiment, a specific waiting location in the waiting area may be determined for the user. The specific location may be determined, for example, when it is desirable to distance the user from at least one other user in the waiting area. The specific waiting location may be provided as the first guidance information for the user.

At 104 location data associated with the user is obtained, the location data providing information about the location of the user. In an example embodiment, the location of the user may be tracked, for example, using various camera systems that may apply, for example, machine vision, or using a radio frequency based tracking system locating, for example, a mobile device of the user. The location data may be still image data or real-time video data. In an example embodiment, the location tracking is provided within the waiting area. In another example embodiment, the location tracking may be started already earlier, i.e. when the user provides the elevator call indication. Yet in another example embodiment, the location of the user may be determined even if the user no longer resides in the waiting area. In an example embodiment, the location data associated with users may be obtained in real-time or near real-time. In another example embodiment, the location data may be obtained at specific time intervals, for example, every two seconds or at an any other interval set by the elevator system.

At 106 an elevator car is allocated in response to the elevator call indication. The allocation takes into account the location of the user. The elevator car may be not allocated for the elevator call indication immediately when the elevator call indication associated with the user is obtained, but only at a later point when the user resides in the waiting area or some other area. The delay between the elevator call indication and the actual elevator car allocation may vary and may depend on various parameters.

In an example embodiment, the location data may indicate that the user’s current location is unfavourable for an elevator car allocation in which the elevator car would arrive within 10 seconds. Based on the location data, it may be possible to determine that the user is located so far away from the elevators that it is not reasonable to allocate the elevator car for the user. The elevator system may make the allocation later after obtaining location data associated with the user again.

In an example embodiment, provision of second guidance information associated with the allocated elevator car may be caused for the user. The second guidance information may be provided, for example, with the user’s mobile device. In another example embodiment, the second guidance information may be provided with an elevator system associated display in vicinity of the user. Yet in another example embodiment, a voice announcement may be provided to the user. The second guidance information may ask the user to approach the allocated elevator car.

In an example embodiment, it may be possible also to ensure, based on the location data, if the user actually enters the elevator car allocated to the user, or if the user enters the correct elevator car. In case the user fails to enter the allocated elevator car and still remains in the waiting area or some other location close to the elevators, an elevator call may be reallocated for the user. In case the user enters an incorrect elevator car, the elevator system may take this into account in the elevator car allocations.

In an example embodiment, the steps discussed above may be performed by an apparatus or a controller associated with an elevator system, for example, an elevator controller.

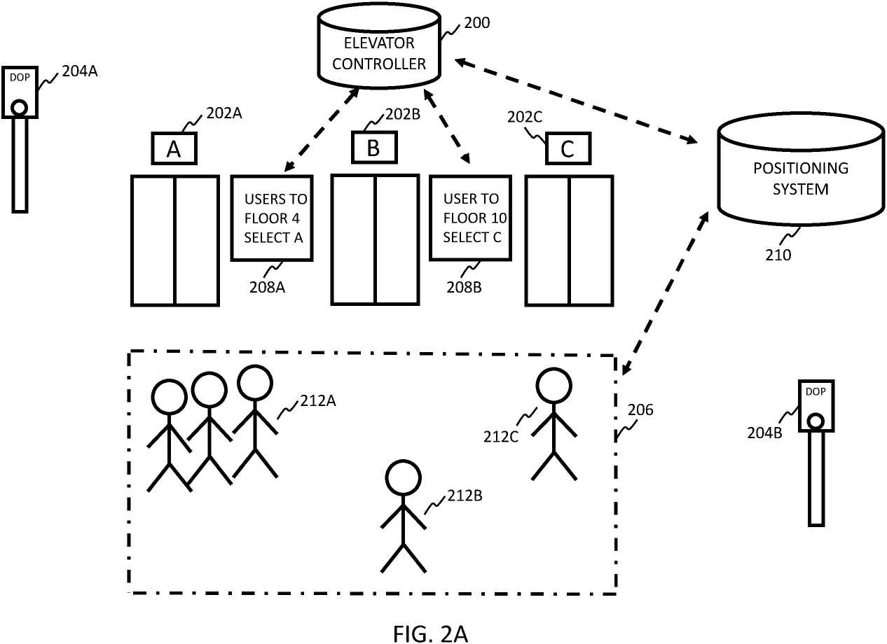

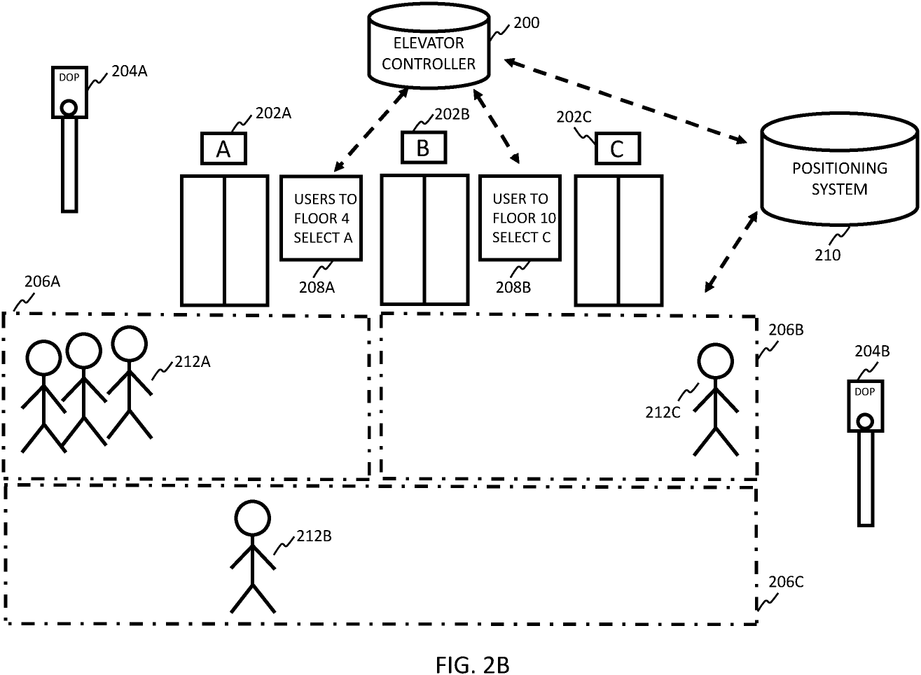

FIG. 2A illustrates elevator system elements according to an example embodiment. One or more of the elevator system elements may implement the method discussed earlier relating to FIG. 1.

When a user approaches elevators 202A, 202B, 202C, the user may provide an elevator call indication, for example, a destination call with a mobile application executed by a mobile device of the user, or with a destination operating panel 204A, 204 that may be arranged in vicinity of the elevators 202A, 202B, 202C.

An elevator controller 200 controlling the operation of the elevator 202A, 202B, 202C receives the destination call, but does not immediate allocate an elevator car for the destination call. The elevator controller 200 may determine a waiting location in a waiting area 206 associated with elevators 202A, 202B, 202C for the user. The waiting location may refer, for example, a specific spot in the waiting area 206 or to a more general part of the waiting area 206, for example, close to one of the elevators 202A, 202B, 202C. Reference 212A illustrates a group of three users, whereas references 212B, 212C illustrate single users.

The waiting location in the waiting area 206 may be determined, for example, by distancing the user from at least one other user in the waiting area 206. Before determining a waiting location for the user in the waiting area 206, location data associated with at least one other user in the waiting area may be obtained, and this data may be taken into account when determining the waiting location. In another example embodiment, the determination may take into account one or more earlier elevator call indications and/or one more elevator calls for which a serving elevator has already been allocated. For example, it may be that when a user is about to place an elevator call, a user relating to an earlier elevator call indication for which an elevator car has already been allocated may shortly start approaching to the elevator as the elevator is approaching the landing floor. Thus, by the time the user that just provided the elevator call indication reaches the waiting area 206, an earlier user on a specific spot in the waiting area 206 has just left and entered his/her elevator.

In another example embodiment, a user may be guided to a waiting location that may not be the closest section of the waiting area 206 to the elevator that will eventually be allocated for the user.

A positioning system 210 may be provided for providing location data associated with the users. The positioning system may, for example, track the users in the waiting area 206. The tracking may be started when the users 212A, 212B, 212C place their destination calls. Alternatively, the tracking may be started only when the users 212A, 212B, 212C reach the waiting area 206. The location of the user may be tracked, for example, using various camera systems that may apply, for example, machine vision or using a radio frequency based tracking system locating, for example, a mobile device of the user. The location data may be still image data or real-time video data. The positioning system 210 may be an integral part of the elevator system, or alternatively, the elevator controller 200 may receive the location data associated with the user 212A, 212B, 212C via an application interface. With the positioning system 210 it may be possible to associate a received elevator call indication to a specific user.

In real life, one of more of the users 212A, 212B, 212C may not remain waiting in the locations originally indicated to them. In other words, they may change they location within the waiting area 206 or even wander outside the waiting area 206. However, as the positioning system may be able to track the users’ 212A, 212B, 212C locations in the waiting area 206, the elevator controller 200 is able to use the locations as parameters for allocating an elevator car for the elevator call indications. The delay between an elevator call indication and the actual elevator car allocation for the elevator call indication may vary and may depend on various parameters. When the elevator controller 200 does not have to make the elevator car allocation immediately after receiving an elevator call indication, the elevator controller 200 is able to take into account data that is obtained after receiving the elevator call indication. As the overall situation with one or more parameters affecting the elevator car allocation may change in time, also the elevator call allocation may change in time.

In an example embodiment, when allocating an elevator car for a destination call associated with a user, the elevator may take into account the location of the user in the waiting area 206. Further, other parameters may also have an effect on the allocation. For example, at least one of the waiting time of a user so far, at least one other elevator call indication obtained but not yet allocated, one or more elevator calls currently being served, locations of at least one other user, the ability to maintain distancing between users in the waiting area 206 etc.

When the elevator car has been allocated for the elevator call indication, guidance information may be provided to the user to guide the user to the allocated elevator car. For example, a display 208A, 208B nearest to the user may be used to inform the user about the allocated elevator. The elevator controller 200 may control the display 208A to display, for example a notification “Users to floor 4 select elevator A” or the display 208B to display, for example a notification “User to floor 10 select elevator C”. The guidance information may additionally or alternatively be provided, for example, with the user’s mobile device and/or with a voice announcement. In an example embodiment, if it can be determined that the user is approaching the allocated elevator car or is already close to the allocated elevator car, it may be possible to omit the step of displaying information on the display 208A, 208.

FIG. 2B illustrates elevator system elements according to another example embodiment. The elevator system elements may implement the method discussed earlier relating to FIG. 1.

The embodiment illustrated in FIG. 2B differs from the one illustrated in FIG. 2A in that the size and/or location of a waiting area 206A, 206B, 206C may vary depending on one or more parameters. For example, during a low traffic situation, the size of the waiting area may be kept smaller than during a high traffic situation. Further, during the high traffic situation, the waiting area may be divided to more than one area. Further, the exact location of the waiting area or areas may vary.

At least some of the above discussed embodiments may improve the flow of people waiting their elevator cars. Further, at least one of the embodiments may allow “social distancing” of the users waiting for their elevators. This means that the waiting location determination and the elevator call allocation may take into account that people are kept sufficiently separated from each other.

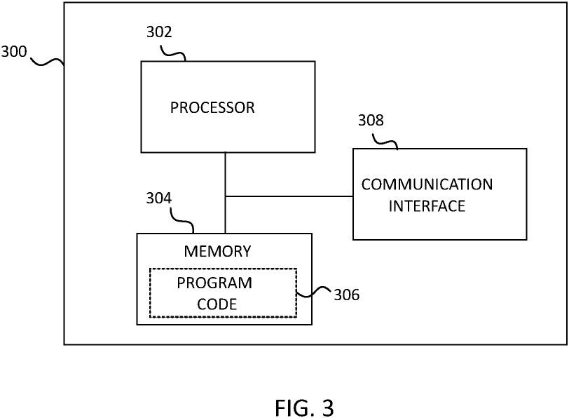

FIG. 3 illustrates an apparatus 300 for allocating an elevator according to an example embodiment. The apparatus 300 may comprise at least one processor 302. The apparatus 300 may further comprise at least one memory 304. The memory 304 may comprise program code 306 which, when executed by the processor 302 causes the apparatus 300 to perform at least one example embodiment. The exemplary embodiments and aspects of the subject-matter can be included within any suitable device, for example, including, servers, elevator controllers, workstations, capable of performing the processes of the exemplary embodiments. The exemplary embodiments may also store information relating to various processes described herein. Although the apparatus 300 is illustrated as a single device it is appreciated that, wherever applicable, functions of the apparatus 300 may be distributed to a plurality of devices.

Example embodiments may be implemented in software, hardware, application logic or a combination of software, hardware and application logic. The example embodiments can store information relating to various methods described herein. This information can be stored in one or more memories 304, such as a hard disk, optical disk, magneto-optical disk, RAM, and the like. One or more databases can store the information used to implement the example embodiments. The databases can be organized using data structures (e.g., records, tables, arrays, fields, graphs, trees, lists, and the like) included in one or more memories or storage devices listed herein. The methods described with respect to the example embodiments can include appropriate data structures for storing data collected and/or generated by the methods of the devices and subsystems of the example embodiments in one or more databases.

The processor 302 may comprise one or more general purpose processors, microprocessors, digital signal processors, micro-controllers, and the like, programmed according to the teachings of the example embodiments, as will be appreciated by those skilled in the computer and/or software art(s). Appropriate software can be readily prepared by programmers of ordinary skill based on the teachings of the example embodiments, as will be appreciated by those skilled in the software art. In addition, the example embodiments may be implemented by the preparation of application-specific integrated circuits or by interconnecting an appropriate network of conventional component circuits, as will be appreciated by those skilled in the electrical art(s). Thus, the examples are not limited to any specific combination of hardware and/or software. Stored on any one or on a combination of computer readable media, the examples can include software for controlling the components of the example embodiments, for driving the components of the example embodiments, for enabling the components of the example embodiments to interact with a human user, and the like. Such computer readable media further can include a computer program for performing all or a portion (if processing is distributed) of the processing performed in implementing the example embodiments. Computer code devices of the examples may include any suitable interpretable or executable code mechanism, including but not limited to scripts, interpretable programs, dynamic link libraries (DLLs), Java classes and applets, complete executable programs, and the like.

As stated above, the components of the example embodiments may include computer readable medium or memories 304 for holding instructions programmed according to the teachings and for holding data structures, tables, records, and/or other data described herein. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may include a computer-readable storage medium that may be any media or means that can contain or store the instructions for use by or in connection with an instruction execution system, apparatus, or device, such as a computer. A computer readable medium can include any suitable medium that participates in providing instructions to a processor for execution. Such a medium can take many forms, including but not limited to, non-volatile media, volatile media, transmission media, and the like.

The apparatus 300 may comprise a communication interface 308 configured to enable the apparatus 300 to transmit and/or receive information, to/from other apparatuses and/or elements associated with an elevator system.

The apparatus 300 may comprise means for performing at least one method described herein. In one example, the means may comprise the at least one processor 302, the at least one memory 304 including program code 306 configured to, when executed by the at least one processor 302, cause the controller 300 to perform the method.

While there have been shown and described and pointed out fundamental novel features as applied to preferred embodiments thereof, it will be understood that various omissions and substitutions and changes in the form and details of the devices and methods described may be made by those skilled in the art without departing from the scope of the claims. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiments may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

1. A method comprising the steps of:
obtaining an elevator call indication associated with a user;
causing provision of first guidance information for the user to proceed to a waiting area;
obtaining location data associated with the user, the location data providing information about the location of the user; and
allocating an elevator car in response to the elevator call indication, wherein the allocation takes into account the location of the user.

2. The method of claim 1, wherein the step of causing provision of first guidance information to the user further comprises the step of causing provision of the first guidance information with at least one of a display associated with the location of the user, a voice announcement and with a mobile application used by the user.

3. The method of claim 1, further comprising the step of causing provision of second guidance information associated with the allocated elevator car for the user.

4. The method of claim 3, wherein the step of causing provision of second guidance information associated with the allocated elevator car for the user further comprises the step of causing provision of the second guidance information with at least one of a display associated with the location of the user, a voice announcement and with a mobile application used by the user.

5. The method of claim 1, further comprising the step of determining for the user a specific waiting location in the waiting area.

6. The method of claim 5, wherein the step of determining for the user a specific waiting location in the waiting area further comprises the step of determining the waiting location by distancing the user from at least one other user in the waiting area.

7. The method of claim 5, further comprising the steps of:
before the step of determining for the user a waiting location in the waiting area, obtaining location data associated with at least one other user in the waiting area; and
distancing the user from the at least one other user based on the location data associated with the at least one other user.

8. The method of claim 1, further comprising the step of changing the size and/or location of the waiting area dynamically.

9. The method of claim 1, further comprising the step of obtaining location data associated with at least one other user, the location data providing information about the location of the at least one other user,
wherein the step of allocating an elevator car in response to the elevator call indication further comprises the step of allocating the elevator car by taking into account the location of the at least one other user in the waiting area.

10. The method of claim 1, wherein the step of allocating an elevator car in response to the elevator call indication further comprises the step of allocating the elevator car by taking into account at least one of existing allocated elevator calls and elevator call indications associated with other users.

11. The method of claim 1, wherein the location data is obtained from an external monitoring system.

12. An apparatus comprising:
means for obtaining an elevator call indication associated with a user;
means for causing provision of first guidance information for the user to proceed to a waiting area;
means for obtaining location data associated with the user, the location data providing information about the location of the user; and
means for allocating an elevator car in response to the elevator call indication, wherein the allocation takes into account the location of the user.

13. The apparatus of claim 12, wherein the means for causing provision of first guidance information to the user are configured to cause provision of the first guidance information with at least one of a display associated with the location of the user, a voice announcement and with a mobile application used by the user.

14. The apparatus of claim 12, further comprising means for causing provision of second guidance information associated with the allocated elevator car for the user.

15. The apparatus of claim 14, wherein the means for causing provision of second guidance information associated with the allocated elevator car to the user are configured to cause provision of the second guidance information with at least one of a display associated with the location of the user, a voice announcement and with a mobile application used by the user.

16. The apparatus of claim 12, further comprising means for determining for the user a specific waiting location in the waiting area.

17. The apparatus of claim 16, wherein the means for determining for the user a specific waiting location in the waiting area are configured to determine the waiting location by distancing the user from at least one other user in the waiting area.

18. The apparatus of claim 16, further comprising:
means for obtaining location data associated with at least one other user in the waiting area before determining for the user a waiting location in the waiting area; and
means for distancing the user from the at least one other user based on the location data associated with the at least one other user.

19. The apparatus of claim 12, further comprising means for changing the size and/or location of the waiting area dynamically.

20. The apparatus of claim 12, further comprising means for obtaining location data associated with at least one other user, the location data providing information about the location of the at least one other user,
wherein the means for allocating an elevator car in response to the elevator call indication are configured to allocate the elevator car by taking into account the location of the at least one other user in the waiting area.

21. The apparatus of claim 12, wherein the means for allocating an elevator car in response to the elevator call indication are configured to allocate the elevator car by taking into account at least one of existing allocated elevator calls and elevator call indications associated with other users.

22. The apparatus of claim 12, wherein the location data is obtained from an external monitoring system.

23. An elevator system comprising:
a plurality of elevator cars; and
the apparatus of claim 12.

24. A computer program embodied on a non-transitory computer readable medium and comprising program code, which when executed by at least one processing unit, causes an apparatus to perform the method of claim 1.

25. (canceled)
